(19) United States
(12) Patent Application Publication
(10) Pub. No.: US 2023/0052692 A1
(43) Pub. Date: Feb. 16, 2023

(54) METHOD FOR A SAFETY BELT SYSTEM, SAFETY BELT SYSTEM FOR A VEHICLE, AND VEHICLE WITH A SAFETY BELT SYSTEM

(71) Applicant: ZF AUTOMOTIVE GERMANY GMBH, Alfdorf (DE)

(72) Inventors: Karl BIRK, Ebersbach (DE); Martin SEYFFERT, Pfullingen (DE)

(21) Appl. No.: 17/789,680

(22) PCT Filed: Dec. 16, 2020
(86) PCT No.: PCT/EP2020/086450

§ 371 Date: Jun. 28, 2022

(30) Foreign Application Priority Data
Dec. 31, 2019 (DE) 10 2019 135 913.9
Dec. 31, 2019 (DE) 10 2019 135 915.5

(51) Int. Cl. B60R 22/48; B60R 21/015

(52) U.S. Cl. CPC B60R 22/48; B60R 21/01544; B60R 2022/4816; B60R 2022/4825

(57) ABSTRACT

A method for a seat belt system (10) in a vehicle (14), wherein the seat belt system (10) comprises an extendable seat belt (18), a webbing extension measuring device (30) and a control unit (36), includes the steps of:
a) determining the webbing extension by means of the webbing extension measuring device (30),
b) determining whether a locking tongue (22) is connected to a belt buckle (24),
c) determining whether the webbing extension is above a threshold.

Moreover, the invention provides a seat belt system (10) for a vehicle (14) comprising an extendable seat belt (18) and a vehicle (14) comprising a seat belt system (10).

### TECHNICAL FIELD

The invention relates to a method for a seat belt system in a vehicle, the seat belt system comprising an extendable seat belt. Moreover, the invention relates to a seat belt system for a vehicle and to a vehicle comprising such a seat belt system.

### BACKGROUND

Seat belt systems for vehicles are basically known. They have the function of restraining a vehicle occupant belted by the seat belt in the event of large forces acting on the vehicle occupant, such as in the case of emergency braking or crash, in the seat and, thus, increasing the safety. The protective effect provided by the seat belt strongly depends on whether or not the vehicle occupant is properly buckled up. The protective effect provided by the seat belt and/or the interaction of the seat belt with further restraint systems, such as airbag systems with inflatable airbags, is additionally strongly dependent on whether or not the vehicle occupant is in a proper seating position.

It is known from prior art to check whether or not a vehicle occupant is belted, for example by determining whether the locking tongue of the seat belt is anchored in the buckle head.

However, this method is not reliable to check whether the vehicle occupant is properly buckled up and/or whether the vehicle occupant is in a proper seating position, as this method is not indicative of the actual webbing extension of the seat belt. In particular, such check can be gamed in that the belt buckle is locked, to be sure, but the webbing extends behind the seat, for example, and not over the vehicle occupant and thus provides no protective effect for the vehicle occupant.

### SUMMARY

It is the object of the invention to provide a method by means of which a vehicle occupant can be more reliably ensured to be properly buckled up. It is another object of the invention to provide a method by means of which it can be determined whether a vehicle occupant is in a proper seating position. Furthermore, it is an object of the invention to provide a seat belt system that is adapted to carry out such method to guarantee an improved protective effect.

For achieving the object, a method for a seat belt system is provided in a vehicle, the seat belt system comprising an extendable seat belt, a webbing extension measuring device and a control unit. The method includes the following steps of:
a) determining the current webbing extension using the webbing extension measuring device, and
b) generating a confirmation signal, if the webbing extension is above a threshold stored in the control unit.

The webbing extension is an important parameter to determine whether a vehicle occupant is properly buckled up. “Properly” in accordance with the invention means that the webbing of the seat belt extends so that the seat belt system provides a high protective effect and, resp., ensures a high degree of safety. In particular, the webbing extends opposite to the seat over the vehicle occupant, i.e., the vehicle occupant is arranged between the belt and the seat. In this case, the body volume of the vehicle occupant results in a specific webbing extension that cannot be undershot without leaving the properly buckled up position of the seat belt. Not proper are specifically states in which the webbing is disposed between the person and the seat or the seat is disposed between the person and the webbing. In particular, in the not proper states, the webbing extension is below the threshold. In this way, the webbing extension can help determine more reliably whether the vehicle occupant is properly buckled up by the seat belt associated to the him/her. The confirmation signal indicates that the condition of a sufficient webbing extension is fulfilled.

Accordingly, it may be provided that, for generating the confirmation signal, in addition to the sufficient webbing extension at least one further condition must be fulfilled which is relevant as to whether the vehicle occupant is properly buckled up. Hereby several preconditions are checked, allowing the belted state of the vehicle occupant to be determined with higher accuracy. Furthermore, it is more difficult to game or to bypass the seat belt system so that misuse can be prevented more reliably. Examples of conditions which are relevant as to whether the vehicle occupant is properly buckled up are as follows: the buckle switch of the belt buckle is locked; the locking tongue of the seat belt has been associated with the buckle head; the image evaluation of a camera system detects that the webbing extends over the torso of the vehicle occupant; the weight sensor detects a weight corresponding to a person sitting in the seat; pressure sensors in the seat and/or the seat back detect a correct seating position of the vehicle occupant.

According to one embodiment, a warning signal is output via an output device to the vehicle occupant, if the confirmation signal is not provided and the vehicle occupant is thus not properly buckled up. In this way, the vehicle occupant is informed about the deficiency and has the opportunity to check and appropriately correct his/her seat belt and/or his/her posture to ensure a proper seat belt position.

The warning signal is a visual, acoustic and/or haptic signal, for example.

It is of advantage when the current webbing extension is measured absolutely or quasi absolutely. Absolutely in this context means that each revolution of the belt reel and, resp., each webbing section that is extended is detected. Quasi absolutely means that the webbing extension measuring device is always active, i.e., it does “not sleep” and has no standby mode in which no measuring takes place. In this way, it is prevented that webbing can be extended or wound up without being detected by the seat belt system. Thus, the actual webbing extension is known at any time and/or can be reliably determined.

The sensor and/or a measuring scale of the webbing measuring device are preferably attached or disposed on the webbing or in the belt retractor on the spindle, the gearwheel or the control disk.

Preferably, at regular time intervals it is determined whether the current webbing extension is above the threshold stored in the control unit so that a proper seat belt extension can be safeguarded over the entire period of use.

A time interval in this context ranges specifically from 5 to 60 seconds, preferably from 10 to 30 seconds, preferably amounts to 15 seconds, so that a quick reaction to changes can be provided.

Unless the confirmation signal is present in the control unit, the speed of the vehicle may be provided to be limited by the control unit to a maximum speed, in particular to a maximum speed of 50 km/h, preferably 30 km/h, preferred 15 km/h. In this way, the safety for the vehicle occupant who is not properly buckled up can be increased, particularly at very low maximum speeds of 20 km/h and less, because in the event of crash the kinetic energy is limited at least on the side of the vehicle including the vehicle occupant. Moreover, the restriction of the maximum speed is a very efficient method to induce the vehicle occupant to properly buckle up.

In one embodiment, the speed of the vehicle is reduced by the control unit, if the confirmation signal is not provided in the control unit. The vehicle can be decelerated especially by activating a braking device of the vehicle and/or by reducing and/or limiting the driving power of the vehicle. The speed of the vehicle is not reduced abruptly but slowly and smoothly, for example at a deceleration of 1 km/h per second to 5 km/h per second, so that the deceleration does not endanger the vehicle occupants, the vehicle and the road traffic. This measure helps ensure that the vehicle is not moved over quite a long time at high speed, if the vehicle occupant is not properly buckled up. This reduces the risk of a serious accident and increases the safety of the vehicle occupant, even if the seat belt is not properly fastened. In addition, this measure forces the vehicle occupant to properly buckle up in order to accelerate the vehicle.

The reduction of the speed is preferably announced prior to decelerating by a warning signal, and/or the driver and/or the vehicle occupants are informed during the decelerating operation so that they are not overtaken by this.

Further, the speed is preferably not reduced to a halt of the vehicle, but the vehicle is decelerated only until a speed threshold is undershot. Thus, the vehicle remains mobile and, consequently, does not obstruct the traffic, for example, and/or can escape from a dangerous situation such as a level crossing.

The speed threshold specifically is the maximum speed to which the vehicle is limited by the control unit, if the confirmation signal which indicates that the vehicle occupant is properly buckled up is not present in the control unit.

According to the invention, for achieving the object there is further provided a method for a seat belt system in a vehicle, the seat belt system comprising an extendable seat belt, a webbing extension measuring device and a control unit. The method includes the following steps of:
c) determining the webbing extension using the webbing extension measuring device,
d) determining whether a locking tongue is connected to a belt buckle,
e) determining whether the webbing extension is above a threshold.

The webbing extension is an important parameter to determine whether a vehicle occupant is properly buckled up. In accordance with the invention, “properly” means that the webbing of the seat belt extends and the vehicle occupant is in a seating position such that the seat belt system and, where necessary, further existing restraint systems, such as an airbag system with an inflatable airbag, provide a high degree of protective effect and, resp., ensure a high degree of safety. In particular, the webbing extends opposite to the seat over the vehicle occupant, i.e., the vehicle occupant is arranged between the belt and the seat and is in a seating position in which his/her back is in contact with the seat back of the vehicle seat.

According to one embodiment, via an output device a warning signal is output to the vehicle occupant, if the locking tongue is not connected to the belt buckle and/or the webbing extension is above the threshold. In this way, the vehicle occupant is informed about the deficiency that the seat belt was not buckled up, or that he/she has taken an improper seating position. The warning signal enables the vehicle occupant to check and appropriately correct his/her seat belt and/or his/her posture to ensure a proper seat belt position.

The warning signal is a visual, acoustic and/or haptic signal, for example.

The threshold of the webbing extension is determined, in a preferred embodiment, via a standard extension of the webbing. The standard extension of the webbing is preferably measured immediately after a vehicle occupant has fastened his/her seat belt. The time of the vehicle occupant's fastening of the seat belt can be determined on the basis of the time at which the locking tongue is connected to the belt buckle. In particular, the standard extension can be measured immediately after the locking tongue was inserted into the belt buckle and no more webbing extension is determined. The threshold can then correspond to the standard extension. Alternatively, the threshold can also correspond to the sum of the standard extension and an additional admissible extension. The additional extension may correspond, for example, to an extension of the webbing which may occur during normal use of the vehicle, such as by steering movements or the driver's shoulder check.

Thus, when the threshold is exceeded, it can be particularly determined that the vehicle occupant is outside a proper seating position. Such seating position of the vehicle occupant is referred to as “out-of-position” (OOP) seating position. Such OOP seating position may exist, for example, if the vehicle occupant leans far forward with his/her torso and, thus, his/her torso is very close to the instrument panel.

Moreover, it may be provided to consider further measured variables for determining the threshold of the webbing extension.

In accordance with one embodiment, it can be particularly checked whether the seat belt was fastened correctly by the vehicle occupant. In this case, the body volume of the vehicle occupant during fastening the seat belt results in a specific webbing extension which cannot be undershot without leaving the properly buckled up position of the seat belt. In particular states in which the webbing is disposed between the person and the seat or the seat is disposed between the person and the webbing are no proper states. In particular, in the improper states the webbing extension is less than the specific webbing extension. In this manner, the webbing extension can help determine easily and reliably whether the vehicle occupant is properly buckled up by the seat belt associated to the her/him. As a matter of course, if an incorrectly buckled webbing is identified, outputting a warning signal can also be provided.

Examples of further measured variables and/or conditions which can be considered to determine the threshold are as follows: the buckle switch of the belt buckle is locked; the locking tongue of the seat belt has been associated with the buckle head; the image evaluation of a camera system detects that the webbing extends over the torso of the vehicle occupant; the weight sensor detects a weight that corresponds to the person seated in the seat; pressure sensors in the seat and/or in the seat back detect a correct seating position of the vehicle occupant; image sensors in the visible and/or invisible light spectrum detect a correct seating position of the vehicle occupant. The afore-listed conditions and/or measured variables can be also used in particular to determine the correct fastening of the seat belt.

It is advantageous when the current webbing extension is measured absolutely or quasi absolutely. Absolutely in this context means that each revolution of the belt reel or, resp., each webbing section that is extended is detected. Quasi absolutely means that the webbing extension measuring device is always active, i.e., it “does not sleep” and, resp., has no standby mode in which no measuring takes place. This prevents webbing from being extended or wound up without being detected by the seat belt system. Thus, the actual webbing extension is known and/or reliably determinable at any time.

The sensor and/or a measuring scale of the webbing measuring device is/are preferably mounted or arranged on the webbing or in the belt retractor on the spindle, the gearwheel or the control disk.

According to one embodiment, it is determined at regular intervals whether the current webbing extension is above the threshold determined by the control unit so that a proper seating position of the vehicle occupant can be ensured over the entire period of use.

A time interval particularly ranges from 0.1 to 15 seconds, preferably from 0.5 to 10 seconds, preferred from 1 to 5 seconds, so that a quick reaction to changes can be provided. Preferably, the warning signal is output by the output device only if the webbing extension is above the threshold determined by the control unit in at least two successive webbing extension measurements. The number of the successive measurements in which the webbing extension is above the threshold determined by the control unit so that a warning signal is output, may also be fixed in response to the time interval, as a matter of course.

In an alternative embodiment, it is permanently determined whether the webbing extension is above the threshold so that a proper seating position of the vehicle occupant can be ensured. Preferably, the warning signal is only output by the output device, if the webbing extension is above the threshold over a defined period of time. The period of time in this case ranges particularly from 1 to 15 seconds and preferably from 2 to 10 seconds.

According to one embodiment, in addition to or as an alternative to outputting the warning signal, the restraint properties of further components of the seat belt system may be adjusted, if the webbing extension is above the threshold. For example, the level of the load limitation of the seat belt system or a tensioning characteristic of a reversible belt tensioner of the seat belt system can be adjusted to the improper seating position of the vehicle occupant.

In accordance with the invention, for achieving the above-mentioned object also a seat belt system for a vehicle is provided comprising an extendable seat belt, a webbing extension measuring device and a control unit which is adapted to carry out the method according to the invention. The seat belt system features the respective advantages of the afore-mentioned method.

The seat belt system may have an activatable emergency mode in which the vehicle is not decelerated and/or the maximum speed of the vehicle is not limited, irrespective of whether or not the vehicle occupant is properly buckled up. Thus, the vehicle can be moved unrestrictedly, for example to escape from an emergency situation, even if the vehicle occupant is not properly buckled up or such buckling is not possible.

Preferably, making use of the emergency mode has an effect that prevents misuse of the emergency mode. For example, the reach of the vehicle in the emergency mode could be restricted. In addition, or alternatively, the activation of the emergency mode could be stored in the control unit and/or could be transmitted to the car manufacturer or any authority in charge of transport safety.

Moreover, according to the invention, for achieving the above-mentioned object a vehicle comprising a vehicle occupant safety system is provided which includes at least a seat belt system according to the invention with the afore-mentioned advantages.

According to one embodiment, the vehicle occupant safety system comprises at least one further restraint system. In an embodiment in which the at least one further restraint system of this type has adaptive properties, the restraint properties of the further restraint system may be provided to be adjusted, if the webbing extension is above the threshold.

### BRIEF DESCRIPTION OF THE DRAWINGS

Further advantages and features result from the following description and from the attached drawings, wherein:

FIG. 1 and FIG. 2 show schematic views of a vehicle according to the invention comprising a seat belt system according to the invention.

### DESCRIPTION

The Figures illustrate a seat belt system 10 for a vehicle occupant 12 in a vehicle 14, which is a passenger car in this case. The vehicle occupant 12 is sitting in a vehicle seat 16 of the vehicle 14. The vehicle 14 has a drive for accelerating the vehicle 14 and a braking device for decelerating the vehicle 14.

In an alternative embodiment, the seat belt system 10 may be provided for any seats in a vehicle 14 to protect the respective vehicle occupant 12 in a case of restraint such as a crash.

In particular, the seat belt system 10 is suited for use in any vehicles, specifically autonomously driving vehicles.

The seat belt system 10 comprises a seat belt 18 with a webbing 20 and a locking tongue 22 as well as a belt buckle 24 which the locking tongue 22 can engage with. The webbing 20 serves to restrain the vehicle occupant 12 in the vehicle seat 16, when the belt buckle 24 is locked. The belt buckle 24 is locked by inserting and engaging the locking tongue 22 in the belt buckle 24.

In an alternative embodiment, the seat belt 18 may have any fastener and may be locked in any way.

Further, the seat belt system 10 comprises a belt retractor 26 with a belt reel 28 on which the webbing 20 is partially wound and which exerts tensile force upon the webbing 20. The webbing 20 and, thus, the seat belt 18 are accommodated in the vehicle 14 to be extendable in this way.

In an alternative embodiment, the webbing 20 may be provided to be extendable in any way.

The belt reel 28 has a webbing extension measuring device 30, for example in the form of a reel rotation sensor by means of which the rotation of the belt reel 28 and, thus, the length of the currently extended webbing 20, the so-called webbing extension, is absolutely detected. In other words, the webbing extension is the length of the part of the webbing 20 that is wound off the belt reel 28.

Basically, the webbing extension measuring device 30 may be any device adapted to determine the webbing extension. For example, the webbing extension measuring device 30 may comprise indirect or direct measuring sensors which measure the webbing extension by direct scanning (e.g., via a friction wheel) and/or indirect scanning (e.g., via a laser sensor scanning a measuring scale integrated on and/or in the webbing).

Moreover, the current webbing extension can be determined in any way, but preferably absolutely or quasi absolutely.

The driver seat 16 includes a pressure sensor 32 adapted to detect the weight of an object disposed on the vehicle seat 16.

The seat belt system 10 further comprises an output device 34 in the form of a display element disposed in the visual range of the vehicle occupant 12.

In an alternative embodiment, the output device 34 may be substantially any output device that is suited to transmit information to the vehicle occupant 12, such as a loudspeaker or a haptic feedback element. Of course, the output device 34 can also be adapted to provide the information to the vehicle occupant 12 simultaneously in the form of different signals, specifically by acoustic, visual and/or haptic signals.

As a matter of course, the output device 34 may be disposed at any place inside the vehicle 14 which is suited for transmitting the information to the vehicle occupant 12. In addition, or alternatively, the output device 34 may be provided by output devices already existing in the vehicle 14, such as loudspeakers, or may be integrated in the same, such as in an instrument panel of the vehicle 14.

The webbing extension measuring device 30, the pressure sensor 32 and the output device 34 are connected to a control unit 36 of the seat belt system 10 for signal transmission.

The control unit 36 is integrated, in the present case, in the onboard computer of the vehicle 14. In an alternative embodiment, the control unit 36 of the seat belt system 10 may be provided separately, being preferably connected to the onboard computer of the vehicle 14 for signal transmission.

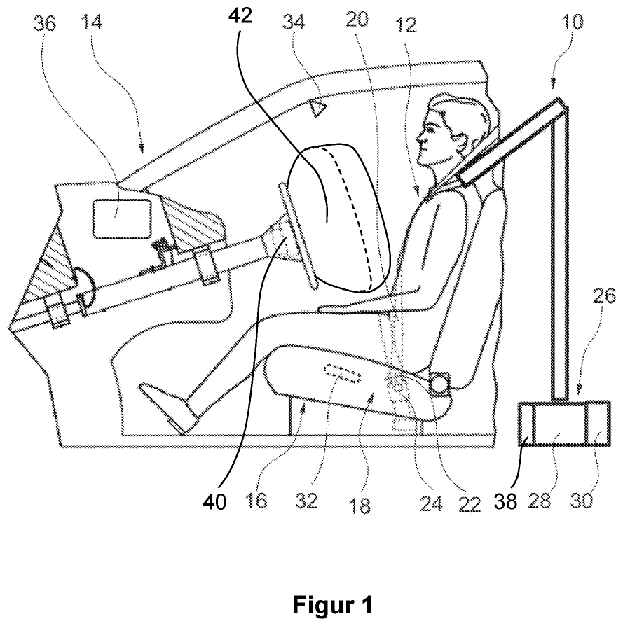

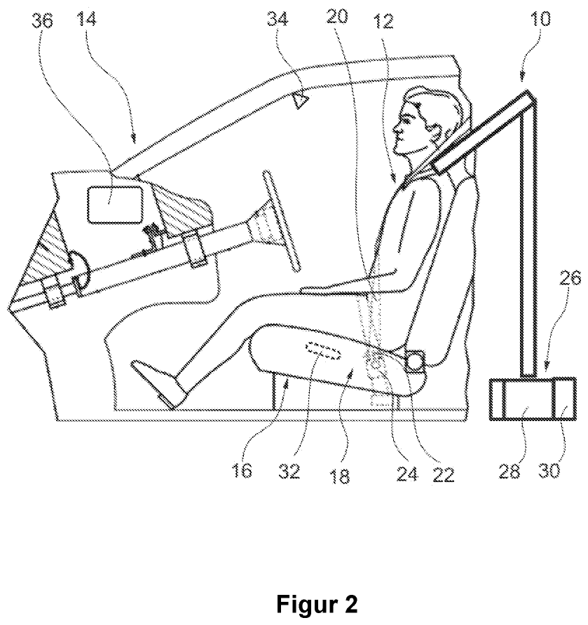

The control unit 36 is adapted, with respect to FIG. 1, to control the afore-mentioned systems and to carry out the following method for operating the seat belt system 10. In particular, the method for operating the seat belt system 10 can be used to check whether the vehicle occupant 12 is in a proper seating position.

Upon starting the vehicle 14, the control unit 36 checks whether the vehicle occupant 12 sitting in the vehicle seat 16 is buckled up by checking whether the locking tongue 22 is connected to the belt buckle 24. If the control unit 36 determines that the locking tongue 22 is not connected to the belt buckle 24, a warning signal can be output by the output device 34.

In an alternative embodiment, the control unit 36 cannot start checking before the vehicle 14 has started to move or the vehicle 14 travels at a specific minimum speed, such as 5 km/h.

In a first step, the pressure prevailing on the vehicle seat 16 is determined to find out in a known way whether a vehicle occupant 12 is sitting in the vehicle seat 16.

In an alternative embodiment, it can be determined in any way whether the seat 16 in the vehicle 14 is occupied by a vehicle occupant 12, for example using a camera. This is particularly useful when the seat is no driver seat and therefore does not necessarily have to be occupied to steer the vehicle 14.

As a matter of course, the check whether the seat 16 is occupied by a vehicle occupant 12 can be dropped, in particular if the seat 16 necessarily has to be occupied by a vehicle occupant 12 when the vehicle 14 is traveling.

In addition, as long as a vehicle occupant 12 is identified in the vehicle seat 16, it can be checked in another checking step whether conditions indicating that the vehicle occupant 12 sitting in the vehicle seat 16 is properly buckled up are fulfilled. To this end, in the checking step the current webbing extension is measured using the webbing extension measuring device 30 and is compared to a specific webbing extension stored in the control unit 36. The specific webbing extension corresponds to the minimum webbing extension that is possible when a vehicle occupant 12 is properly buckled up in the vehicle seat 16. In so doing, it is advantageous when the position of the driver seat 16 is taken into account for the specific webbing extension, as, depending on the position of the driver seat 16, the minimum webbing extension is different in terms of size. For example, the minimum webbing extension may be larger when the seat back of the vehicle seat 16 is vertical than when the seat back is reclined.

In addition, or alternatively, the corpulence of the vehicle occupant 12 can be taken into account in the specific webbing extension, for example by determining the weight of the vehicle occupant 21 by the pressure sensor 32 and concluding the body volume from said weight. In addition, or as an alternative, the corpulence of the vehicle occupant 12 can be detected using a camera.

If the webbing extension is less than the specific webbing extension, the vehicle occupant 12 can be warned via the output device 34 by means of a warning signal that he/she is not properly buckled up.

After determining whether the vehicle occupant 12 is (properly) buckled up, the control unit determines whether the webbing extension is above a threshold.

For determining the threshold of the webbing extension, a standard extension of the seat belt 18 can be used. The standard extension of the seat belt is measured for this purpose directly after the seat belt 18 is fastened by a vehicle occupant 12. Accordingly, specifically the extension length of the webbing 20 is determined by the webbing extension measuring device 30.

The standard extension of the webbing 20 is preferably measured directly after the seat belt 18 is fastened by a vehicle occupant 12. The time of fastening the seat belt 18 by the vehicle occupant 12 can be determined based on the time at which the locking tongue 22 is connected to the belt buckle 24. In particular, the standard extension can be measured immediately after the locking tongue 22 has been inserted into the belt buckle 24 and also no more webbing extension is detected. The threshold can then correspond to the standard extension. As an alternative, the threshold can also correspond to the sum of the standard extension and an additional admissible extension of the webbing 20. The additional extension may correspond, for example, to an extension of the webbing 20 which may occur during normal use of the vehicle 14, such as by steering movements or the driver's shoulder check.

In an alternative embodiment, for determining the threshold, alternatively or additionally to the standard extension further measured variables and/or conditions may be taken into account and/or required.

One embodiment may provide that the restraint properties of further restraint components 38, such as a load limiter and/or a belt tensioner, of the seat belt system 10 are adjusted by the control unit 36, if the webbing extension is above the threshold. This can be done in addition or as an alternative to outputting the warning signal. For example, the level of load limitation of the seat belt system 10 or a tensioning characteristic of a reversible belt tensioner of the seat belt system 10 can be adjusted to the improper seating position of the vehicle occupant 12.

The check whether the threshold is exceeded is carried out by the control unit 36 at regular time intervals. A warning signal is output by the output device 34 in particular only if the webbing extension is above the threshold in at least two successive webbing extension measurements.

In an alternative embodiment, it is permanently determined via the webbing extension measuring device 30 whether the webbing extension is above the threshold. A warning signal is output by the output device 34 in particular only if the webbing extension is above the threshold over a defined period of time.

If the webbing extension is above the threshold, there is a measure to give a warning signal by means of the output device 34 to inform the vehicle occupant 12 about the fact that he/she has taken an improper seating position.

In another embodiment, the restraint properties of further restraint components 38 such as a load limiter and/or a belt tensioner of the seat belt system 10 can be provided to be adjusted by the control unit 36, if the webbing extension is above the threshold. This can be done in addition to or alternatively to the output of the warning signal. For example, the level of the load limitation of the seat belt system 10 or a tensioning characteristic of a reversible belt tensioner of the seat belt system 10 can be adjusted to the improper seating position of the vehicle occupant 12.

The warning signal in the present embodiment is a flashing element of the display unit in the form of a seat belt. Basically, the warning signal can be any signal, however, that is suited to inform the vehicle occupant 12 of the fact that he/she is not (properly) buckled up or is not in a proper seating position.

It is a further measure to adjust the restraint properties of further components of the seat belt system 10 and/or to adjust the restraint properties of further restraint systems of the vehicle occupant safety system of the vehicle 14. The vehicle occupant safety system of the vehicle 14 comprises specifically an above-described seat belt system 10. The further restraint systems of the vehicle occupant safety system may comprise, for example, an adaptive airbag system comprising an airbag module 40 with an adaptive airbag 42, as exemplified by the driver airbag 42 in FIG. 1. Such airbag 42 may comprise, for example, a valve which is switchable by the control unit 36 in the case of release. Also, such an adaptive airbag 42 may comprise a tether device which is switchable by the control unit 36 so that the inflatable volume and/or the expansion of the airbag 42 can be adjusted and specifically restricted, if the threshold is exceeded.

The seat belt system 10 is not restricted to one single seat belt 18 that is monitored, but it may comprise several seat belts 18 to check whether several, in particular all, vehicle occupants 12 are (properly) buckled up and are in a proper seating position in which a preferably high and efficient protective effect can be achieved by the seat belt system and/or further restraint systems of the vehicle occupant safety system of the vehicle 14.

Preferably, in this case the seat belt system 10 is adapted so that the warning signal can be transmitted individually to the vehicle occupants 12 who are not properly buckled up, and/or that it is possible to associate the warning signal with a specific seat belt 18 by the vehicle occupants 12.

The control unit 36 is adapted to control the afore-mentioned systems and to carry out the following method for operating the seat belt system 10.

When the vehicle 14 is started, the control unit 36 checks whether the vehicle occupant 12 seated in the driver seat 16 is properly buckled up.

In an alternative embodiment, the control unit 36 can start to check only when the vehicle 14 starts to move or the vehicle 14 travels at a defined minimum speed, such as 5 km/h.

In a first step, the pressure weighing on the driver seat 16 is detected by means of the pressure sensor 32 to determine in a known way whether a vehicle occupant 12 is sitting in the vehicle seat 16.

In an alternative embodiment, it can be determined in any way, for example using a camera, whether the seat 16 in the vehicle 14 is occupied by a vehicle occupant 12. This is useful in particular when the seat 16 is no driver seat and therefore does not necessarily have to be occupied to steer the vehicle 14.

As a matter of course, the check of whether the seat 16 is occupied by a vehicle occupant 12 can be dropped, in particular when the seat 16 necessarily has to be occupied by a vehicle occupant 12 while the vehicle 14 is traveling.

As long as a vehicle occupant 12 is identified in the vehicle seat 16, in a checking step it is checked whether the conditions indicating that the vehicle occupant 12 seated in the driver seat 16 is properly buckled up are fulfilled.

For this purpose, in the checking step, the current webbing extension is measured by means of the webbing extension measuring device 30 and is compared to a threshold stored in the control unit 36.

The threshold corresponds to the minimum webbing extension which is possible when a vehicle occupant 12 is properly buckled up in the vehicle seat 16.

Accordingly, it is of advantage when the position of the driver seat 16 is taken into account in the threshold, as depending on the position of the driver seat 16 the minimum webbing extension is different in size. For example, the minimum webbing extension can be larger when the seat back of the driver seat 16 is vertical than when the seat back is reclined.

In addition, or alternatively, the corpulence of the vehicle occupant 12 can be taken into account in the threshold, for example by determining the weight of the vehicle occupant 12 by means of the pressure sensor 32 and concluding the body volume from said weight. In addition, or as an alternative, the corpulence of the vehicle occupant 12 can be determined using a camera.

If the webbing extension is larger than the threshold, a confirmation signal is generated in the control unit 36, for example by putting a variable in the control unit 36 to a value indicating that the conditions for the vehicle occupant 12 seated in the driver seat 16 being properly buckled up are fulfilled.

In an alternative embodiment, further conditions may be required so that the confirmation signal is generated in the control unit 36. It may be such condition that the locking tongue 22 is engaged in the belt buckle 24, wherein it is checked, for example, whether an electric contact between the locking tongue 22 and the belt buckle 24 is locked.

It can further be checked whether the current webbing extension does not exceed an upper threshold, i.e., that the webbing extension is within a range between the (lower) threshold and the upper threshold. In this way, it can be identified whether the webbing is closely adjacent to the body of the vehicle occupant 12 or not, such as in the event of a belt slack.

Preferably, for the upper threshold, analogously to the lower threshold, the seat position and/or the corpulence of the vehicle occupant is/are taken into account.

Accordingly, the checking step is performed by the control unit 36 at regular intervals of 5 seconds, for example, i.e., at a frequency of 0.2 Hz, to check whether the conditions are fulfilled and to correspondingly generate or cancel the confirmation signal.

In an alternative embodiment, the intervals at which the control unit 36 performs the checking step may have any length. Preferably, the intervals range from 5 to 60 seconds, preferred from 10 to 30 seconds, for example are 15 seconds.

If the confirmation signal is not provided, i.e., the conditions indicating that the vehicle occupant 12 sitting in the driver seat 16 is properly buckled up, are not fulfilled, the following measures are initiated and, resp., taken by the control unit 36.

One measure consists in giving a warning signal by means of the output device 34.

The warning signal in the present embodiment is a flashing element of the display device in the form of a seat belt. Basically, the warning signal may be any signal, however, that is suitable to inform the vehicle occupant 12 that he/she is not properly buckled up, for example a recurring warning or beeping sound or a vibration of the webbing.

It is another measure to reduce the speed of the vehicle 14 by throttling the driving power of the vehicle 14 by the control unit 36.

In addition, or as an alternative, the control unit 36 can activate the braking device of the vehicle 14 to decelerate the vehicle 14.

Moreover, it is another measure to limit the maximum speed of the vehicle 14.

The maximum speed can be 50 km/h, preferably 30 km/h or, further preferred, 15 km/h.

In the present embodiment, the speed of the vehicle 14 is only reduced as long as the current speed of the vehicle 14 is above the maximum speed.

The above-described measures can be taken individually or in combination with each other. In addition, or alternatively, the measures or the combinations of measures can be carried out at different times, especially in an escalating manner.

In particular, first the warning signal is transmitted alone to enable the vehicle occupant 12 to correct the extension of the seat belt and to buckle up properly.

If the confirmation signal is still not provided after a certain period of time, such as 30 seconds, after it was started to transmit the warning signal alone, then additional measures are initiated, in particular the maximum speed of the vehicle 14 is limited and/or the vehicle 14 is decelerated.

If the configuration signal is provided, i.e., the conditions indicating that the vehicle occupant 12 sitting in the driver seat 16 is properly buckled up are fulfilled, the above-mentioned measures are lifted and, resp., are not carried out by the control unit 36. In particular, the vehicle 14 is not continued to be decelerated and the maximum speed of the vehicle 14 is not continued to be limited.

The control unit 36 can comprise an activatable emergency mode in which the mobility of the vehicle 14 is not restricted, if the confirmation signal is not provided. In particular, neither the maximum speed of the vehicle 14 is limited, nor the speed of the vehicle 14 is reduced.

In the emergency mode, for example the confirmation signal can be generated even if the conditions required for this purpose are not fulfilled.

The emergency mode can be activated manually by the vehicle occupant 12 and/or automatically by the control unit 36, if the control unit 36 identifies an emergency situation.

The seat belt system 10 is not restricted to one single seat belt 18 that is monitored, but it may comprise several seat belts 18 to check whether several, in particular all, vehicle occupants 12 are properly buckled up.

In this case, the seat belt system 10 is preferably adapted so that the warning signal can be transmitted individually to the vehicle occupants 12 who are not properly buckled up, and/or that it is possible to associate the warning signal to a specific seat belt 18 by the vehicle occupants 12.

In order to increase the safety of the vehicle occupants 12, it is of advantage when the vehicle 14 is decelerated and/or the speed of the vehicle 14 is limited, if at least one vehicle occupant 12 is not properly buckled up.

In the above-described manner, it can be reliably determined using the seat belt system 10 whether a vehicle occupant 12 is properly buckled up.

By monitoring the webbing extension, misuse or bypassing of the safety system 10 is further prevented or at least made more difficult.

Furthermore, the method ensures that the vehicle occupant 12 is properly buckled up, in particular as the vehicle occupant 12 is motivated by the imminent loss of mobility of the measures to buckle up properly.

The invention is not restricted to the illustrated embodiment. Especially individual features of one embodiment may be combined at will with features of other embodiments, in particular independently of the other features of the respective embodiments.

1-18. (canceled)

19. A method for a seat belt system (10) in a vehicle (14), the seat belt system (10) comprising an extendable seat belt (18), a webbing extension measuring device (30) and a control unit (36), with the steps of:
a) determining the webbing extension using the webbing extension measuring device (30), and
b) generating a confirmation signal, if the webbing extension is above a threshold.

20. The method according to claim 19, wherein for generating the confirmation signal at least one further condition must be fulfilled which is relevant as to whether the vehicle occupant (12) is properly buckled up.

21. The method according to claim 19, wherein a warning signal is output via an output device (34), if the confirmation signal is not provided.

22. The method according to claim 19, wherein it is determined at time intervals whether the webbing extension is above the threshold, in particular wherein one time interval ranges from 5 to 60 seconds, preferably from 10 to 30 seconds, preferred amounts to 15 seconds.

23. The method according to claim 19, wherein, if the confirmation signal is not provided, the speed of the vehicle (14) is limited to a maximum speed, specifically to a maximum speed of 50 km/h, preferably 30 km/h, preferred 15 km/h.

24. The method according to claim 19, wherein, if the confirmation signal is not provided, the speed of the vehicle (14) is reduced, particularly by activating a braking device and/or by reducing the driving power of the vehicle (14).

25. A method for a seat belt system (10) in a vehicle (14), the seat belt system (10) comprising an extendable seat belt (18), a webbing extension measuring device (30) and a control unit (36), with the steps of:
a) determining the webbing extension by means of the webbing extension measuring device (30),
b) determining whether a locking tongue (22) is connected to a belt buckle (24),
c) determining whether the webbing extension is above a threshold.

26. The method according to claim 25, wherein a warning signal is output via an output device (34), if the locking tongue (22) is not connected to the belt buckle (24) and/or the webbing extension is above the threshold.

27. The method according to claim 25, wherein a determination of the threshold of the webbing extension is determined by a standard extension of the seat belt (18), the standard extension being measured immediately after a vehicle occupant (12) fastens the seat belt (18).

28. The method according to claim 27, wherein for determining the threshold of the webbing extension further measured variables and/or conditions are taken into account.

29. The method according to claim 25, wherein the restraint properties of further components of the seat belt system (10) are adjusted, if the webbing extension is above the threshold.

30. The method according to claim 25, wherein it is determined at time intervals whether the webbing extension is above the threshold, wherein a warning signal is output by the output device (34) in particular only if, during at least two successive webbing extension measurements, the webbing extension is above the threshold.

31. The method according to claim 25, wherein it is permanently determined whether the webbing extension is above the threshold, wherein a warning signal is output by the output device (34) in particular only if the webbing extension is above the threshold over a defined period of time.

32. The method according to claim 19, wherein the webbing extension is measured absolutely or quasi absolutely.

33. A seat belt system (10) for a vehicle (14) comprising an extendable seat belt (18), a webbing extension measuring device (30) and a control unit (36) which is adapted to carry out the method according to claim 19.

34. A seat belt system (10) for a vehicle (14), comprising an extendable seat belt (18), a webbing extension measuring device (30) and a control unit (36) which is adapted to carry out the method according to claim 23, the seat belt system (10) having an activatable emergency mode in which the vehicle (14) is not decelerated and/or the maximum speed of the vehicle (14) is not limited.

35. A vehicle (14) comprising a vehicle occupant safety system comprising at least a seat belt system (10) according to claim 33.

36. The vehicle (14) according to claim 35, wherein the vehicle occupant safety system comprises at least a further restraint system, in particular wherein restraint properties of the restraint system are adjusted if the webbing extension is above the threshold.

37. The method according to claim 25, wherein the webbing extension is measured absolutely or quasi absolutely.

38. A seat belt system (10) for a vehicle (14) comprising an extendable seat belt (18), a webbing extension measuring device (30) and a control unit (36) which is adapted to carry out the method according to claim 25.

39. A seat belt system (10) for a vehicle (14), comprising an extendable seat belt (18), a webbing extension measuring device (30) and a control unit (36) which is adapted to carry out the method according to claim 24, the seat belt system (10) having an activatable emergency mode in which the vehicle (14) is not decelerated and/or the maximum speed of the vehicle (14) is not limited.

40. A vehicle (14) comprising a vehicle occupant safety system comprising at least a seat belt system (10) according to claim 34.
